(19) United States
(12) Patent Application Publication
(10) Pub. No.: US 2007/0160745 A1
(43) Pub. Date: Jul. 12, 2007

(54) Manufacturing method for white light emitting diode device including two step cure process

(75) Inventor: Jun-Kyu Park, Kyungki-do (KR)

Correspondence Address: JHK LAW, P.O. BOX 1078, LA CANADA, CA, 91012-1078, US

(73) Assignee: MEDIANA ELECTRONICS CO., LTD., CHUNGCHEONGBUK-DO (KR)

(21) Appl. No.: 10/595,907

(22) PCT Filed: Nov. 24, 2004
(86) PCT No.: PCT/KR04/03045

§ 371 Date: May 18, 2006

(30) Foreign Application Priority Data
Nov. 25, 2003 (KR) 10-2003-0084173

(51) Int. Cl. B05D 5/12; B05D 5/06

(52) U.S. Cl. 427/66; 427/58

(57) ABSTRACT

Provided is a method of manufacturing a light emitting diode (LED) device which has excellent optical properties. The method includes: mixing a main gradient with a curing agent at room temperature to obtain the liquid epoxy resin; semi-curing the liquid epoxy resin at 70-100° C. under 1-30 torr; adding a phosphor to the semi-cured liquid epoxy resin at room temperature and mixing the phosphor and the semi-cured liquid epoxy resin to obtain a mother resin mixed with the phosphor; feeding the obtained product into an element to be molded comprising a LED chip; and completely curing the mother resin at 120° C. or higher under an ambient pressure.

### TECHNICAL FIELD

The present invention relates to a method of manufacturing a light emitting diode (LED) device, and more particularly to, a method of manufacturing a white LED device using a liquid epoxy resin.

### BACKGROUND ART

The ranges of applications in which white LED devices are used continue to increase. White LED devices are used in backlight elements of various apparatuses including display devices, lighting products, and various signal displays, etc. When the phosphors of white LED devices are exposed to blue light (a wavelength of about 440-475 nm) or UV light (a wavelength of about 350-410 nm) emitted from blue or UV light LED chips, they change the incident blue or UV light to longer wavelength light, and thus, the white LED devices emit white light outward.

A phosphor (fluorescent pigment) changes UV light or blue light to light having a wavelength different than the UV light or blue light. The phosphor is generally dispersed in an epoxy resin for molding used to protect LED chips and a dispersion state of the phosphor in the epoxy resin has a great effect on characteristics of a white LED device, such as, luminous intensity, color distribution, and reliability of white LED devices. That is, to obtain a white LED device having excellent quality, the phosphor must be uniformly dispersed in the epoxy resin.

However, while an epoxy resin has a specific gravity of about 1.1-1.5, a phosphor has a specific gravity of about 3.8-6.0. Thus, when the phosphor is added to the epoxy resin, the phosphor settles in the epoxy resin due to the difference between their specific gravities. This difference in the specific gravity is an obstacle to obtaining white LED devices having excellent optical properties by uniformly dispersing the phosphor in the epoxy resin.

Further, the epoxy resin is subjected to a curing process in which the epoxy resin is heated and cured, and the viscosity of the epoxy resin decreases at the beginning of the curing process and gradually increases until the epoxy resin is cured. The phosphor is more likely to settle at the beginning of the curing process since the phosphor settles faster for lower viscosities of the epoxy resin.

To obtain white LED devices having excellent optical qualities, the settlement of the phosphor at the beginning of the curing process due to a decrease in the viscosity of the liquid epoxy resin must be prevented or suppressed.

### BRIEF DESCRIPTION OF THE DRAWINGS

FIG. 1 is a graph illustrating a thermal budget applied to an epoxy resin in a method of manufacturing a white LED device comprising a two-step curing process according to an embodiment of the present invention;

FIG. 2 is a schematic cross-sectional view of a white LED lamp manufactured according to an embodiment of the present invention;

FIG. 3 is a schematic cross-sectional view of a white LED chip manufactured according to an embodiment of the present invention;

FIG. 4 is a schematic cross-sectional view of a white LED chip including an injection mold housing package according to an embodiment of the present invention; and

FIG. 5 is a viscosity vs. time graph of liquid epoxy resins during a complete curing process according to an embodiment of the present invention and during a one-step curing process according to a conventional method.

### DETAILED DESCRIPTION OF THE INVENTION

### Technical Goal of the Invention

The present invention provides a method of manufacturing a white light emitting diode (LED) device which has high luminous intensity and reliability and low color distribution variation by uniformly dispersing a phosphor in an epoxy resin.

The present invention also provides a method of manufacturing a white LED device with low production costs in a simplified process.

### Disclosure of the Invention

According to an embodiment of the present invention, there is provided a method of manufacturing a white LED device comprising a two-step curing process. In the present method, a liquid epoxy resin is semi-cured before completely curing a mixture of the liquid epoxy resin and a phosphor. Since the semi-curing is performed, settlement of the phosphor, etc. can be prevented during the complete curing process. Thus, a white LED device having the phosphor uniformly dispersed in the epoxy resin can be manufactured using this method. The characteristics of the present invention can be accomplished by previously semi-curing the liquid epoxy resin before completely curing the mixture of a liquid epoxy resin and a phosphor, thereby attenuating the effect of the viscosity of the epoxy resin being decreased at the beginning of the complete curing process.

According to an exemplary embodiment of the present invention, first, a main gradient and a curing agent is subjected to a first mixing at room temperature to obtain a liquid epoxy resin. The epoxy resin may or may not comprise a phosphor. Then, the liquid epoxy resin is semi-cured at 70-100° C. under low pressure, for example, 1-30 torr, and then, the temperature is lowered to room temperature. A phosphor is added to the semi-cured liquid epoxy resin and is subjected to a second mixing to obtain a mother resin mixed with the phosphor. The addition of the phosphor to the semi-cured liquid epoxy resin can be omitted when a sufficient amount of phosphor is added to the liquid epoxy resin in the first mixing. Subsequently, the obtained product is fed into an element to be molded comprising an LED chip, and then, the mother resin is completely cured at 120° C. or higher under an ambient pressure. In the complete curing process, the mother resin is completely cured. Little decrease in viscosity of the epoxy resin occurs at the beginning of the complete curing process, and thus, the phosphor can be uniformly dispersed in the mother resin. After the complete curing of the mother resin, a white LED device is obtained.

The feeding of the mother resin may be performed by a potting method or a screen pattern masking method.

The main gradient may be cresol novolac epoxy, phenol novolac epoxy, bisphenol A epoxy, or a mixture thereof. The curing agent may be an acid anhydride, a modified aromatic amine, phenol novolac epoxy, or a mixture thereof.

### Effect of the Invention

In a method of manufacturing a white LED device according to an embodiment of the present invention, a liquid epoxy resin is aged and semi-cured before a complete curing process, and thus, its viscosity does not greatly decrease in the complete curing process. The aged and semi-cured liquid resin may be cured at a high temperature in a short time. Thus, a phosphor, which has higher specific gravity than the epoxy resin, does not settle during the complete curing process. Since the phosphor can be uniformly dispersed in the cured epoxy resin, variance of its color distribution is low, thereby producing a white LED which has excellent manufacturing reproducibility.

According to an embodiment of the present invention, the complete curing process, which is performed at a relatively high temperature, can be performed in a shorter time than a conventional method, and thus, the lifetime of the white LED device can be increased. Further, since unnecessary additives such as a silicone resin are not required, the white LED device can be manufactured at low production costs.

### BEST MODE FOR CARRYING OUT THE INVENTION

The above and other features and advantages of the present invention will become more apparent by describing in detail exemplary embodiments thereof with reference to the attached drawings. However, the invention is not limited to these embodiments, but can be realized in various forms. These embodiments are given for the purpose of illustration and scope of the present invention will be defined by the claims. Like reference numerals in the drawings denote like elements.

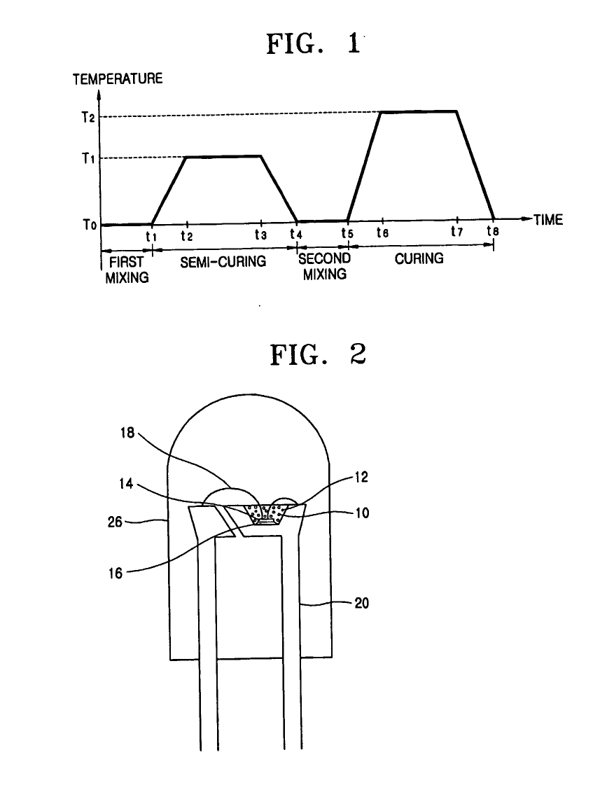

FIG. 1 is a graph illustrating a thermal budget applied to an epoxy resin in a method of manufacturing a white LED device comprising a two-step curing process according to an embodiment of the present invention.

Referring to FIG. 1, first, a main gradient and a curing agent are subjected to a first mixing to obtain a liquid epoxy resin. A phosphor may be added in the first mixing process.

The phosphor is a material which adsorbs UV light or blue light and emits light having a longer wavelength than the incident UV light or blue light. The type of the phosphor is not specifically limited. The phosphor may be a conventional phosphor. In the present embodiment, a silicone resin or EMC powder is not added during the first mixing process. Examples of the main gradient include cresol novolac epoxy, phenol novolac epoxy, bisphenol A epoxy, or a mixture thereof.

Examples of the curing agent include an acid anhydride, a modified aromatic amine, phenol novolac epoxy, or a mixture thereof. If necessary, a curing accelerator, such as an imidazole compound or an amine compound, can be further added in the mixing to accelerate the curing reaction.

Subsequently, the liquid epoxy resin mixture is semi-cured. As illustrated in FIG. 1, the semi-curing process is performed at a predetermined temperature (T₁) for a predetermined time (t₄-t₁). The temperature and duration of the semi-curing are dependent on each other, and particularly, the time required to heat the epoxy resin mixture to the temperature (T₁) can vary according to the type or temperature of the liquid epoxy resin. For example, if the temperature (T₁) is about 80-100° C., a time for raising the temperature (t₂-t₁) may be about 30 minutes, a time (t₃-t₂) during which the liquid epoxy resin is maintained at the temperature (T₁) may be about 1-2 hours, and a time for lowering the temperature (t₄-t₃) may be about 30 minutes. T₀ denotes room temperature. The semi-curing process is performed under low pressure in order to prevent foam from occurring in a final product. The pressure may be, for example, about 1-30 torr. In the semi-curing, the liquid epoxy resin is aged to a semi-cured liquid epoxy resin.

The semi-cured liquid epoxy resin is then subjected to a second mixing to obtain a mother resin. The second mixing process is performed such that the constituents of the semi-cured liquid epoxy resin are intimately mixed. When a phosphor is added in the first mixing process, the phosphor is also intimately mixed during the second mixing process.

The phosphor may be further added to the semi-cured liquid epoxy resin in the second mixing process. The second mixing is performed at room temperature and the second mixing time (t₅-t₄) is not specifically limited.

The concentration of the phosphor in the mother resin can vary according to the characteristics of the white LED device desired. For example, the final concentration of the phosphor may be about 2.0-25% by weight based on the weight of the mother resin. The luminous intensity and wavelength of white light emitted from the white LED chip can be controlled by adjusting the weight ratio of the phosphor and the mother resin.

Next, a white LED chip is molded and cast using the resultant mother resin.

The molding and casting of the LED chip 14 can be performed using a variety of methods. Representative methods are illustrated in FIGS. 2 through 4, in which a white LED device has a conventional structure. The LED chip 14 is bonded to a chip support (not shown), a lead frame or substrate 22 with a silver adhesive 16 and is electrically connected to a connection pad or lead 22 via a bonding wire 18 using a conventional method. The present invention is characterized in that an epoxy resin used in the molding and casting process is the aged and semi-cured epoxy resin, unlike the conventional method.

FIG. 2 is a schematic cross-sectional view of a white LED lamp manufactured according to an embodiment of the present invention. Referring to FIG. 2, after an LED chip 14 bonded to a chip support (not shown) formed in a groove shape in the upper portion of an electrode and a reflective plate portion 20 with a silver adhesive 16 is electrically connected via a bonding wire 18, molding is performed by potting a mother resin 10 mixed with a phosphor 12 to the upper portion to the LED chip 14. An external shape of the white LED lamp is cast using a mold cup 26.

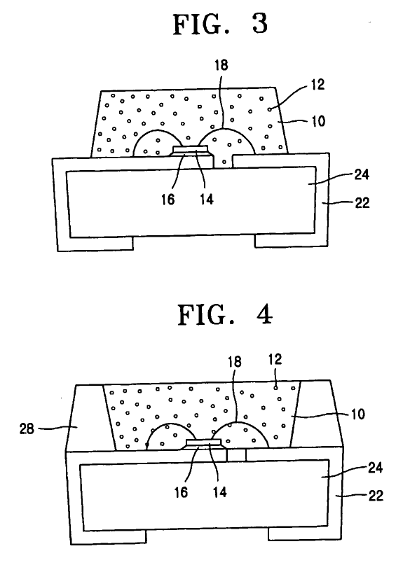

FIG. 3 is a schematic cross-sectional view of a white LED device in the form of a chip manufactured according to an embodiment of the present invention. FIG. 4 is a schematic cross-sectional view of a white LED device in the form of a chip including an injection mold housing package manufactured according to an embodiment of the present invention. Referring to FIGS. 3 and 4, the white LED device in the form of a chip is formed by casting a LED chip 14 mounted on a lead frame or substrate 22 using a screen pattern metal mask.

Referring to FIGS. 2 through 4, after molding the LED chip 14 using the semi-cured mother resin 10 mixed with the phosphor 12, the resultant product is completely cured. In the complete curing process, the semi-cured mother resin 10 is completely cured. The complete curing may be performed under an atmospheric pressure, unlike the semi-curing process. The complete curing is performed at a temperature (T₂) greater than the semi-curing temperature (T₁) for a predetermined time (t₈-t₅). For example, the complete curing process may be performed at about 120-130° C. for about 1-2 hours. More specifically, the complete curing process may comprise raising the temperature for about 30 minutes (t₆-t₅), maintaining the semi-cured mother resin 10 at about 130° C. for about 1 hour (t₇-t₆), and lowering the temperature for about 30 minutes (t₈-t₇). Like in the semi-curing process, the temperature and time of the complete curing are dependent on each other, and particularly, the time during which the temperature (T₂) is maintained can vary according to the type or temperature of the liquid epoxy resin and a thermal budget in the semi-curing process.

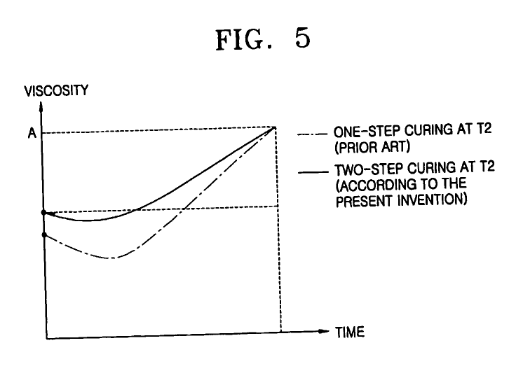

FIG. 5 is a viscosity vs. time graph of liquid epoxy resins during a complete curing process according to an embodiment of the present invention and during a one-step curing process according to a conventional method. In both cases, the heating temperatures (T₂) during curing are identical. Referring to FIG. 5, when a mixture of the semi-cured mother resin 10 and the phosphor 12 is completely cured after the semi-curing process according to an embodiment of the present invention, a decrease in the viscosity of the liquid epoxy resin at the begining of the complete curing process (designated by a sold line) is remarkably lower than that of the liquid epoxy resin at the begining of the one-step curing process according to the conventional method (designated by a dotted line). Accordingly, according to the present invention, the phenomenon that the phosphor, which has higher specific gravity than the epoxy resin, settles during the curing process can be remarkably suppressed. Thus, the phosphor can be uniformly dispersed in the mother resin.

After the complete curing process, the mother resin 10 mixed with the phosphor 12 is completely cured, and elements for casting, etc. are removed from the resultant product, thereby obtaining one of the white LED devices illustrated in FIGS. 2 through 4. The obtained white LED device is tested for color coordinate and luminous intensity and classified according to the measured values, and then, is wound on a ring using automated equipment and shipped.

The white LED device manufactured according to an embodiment of the present invention is used in displays of apparatuses emitting white light for electronic products, such as portable wireless communication apparatuses, automobiles, and electric home appliances, etc. or for backlights of liquid crystal displays, etc., as well as for all kinds of apparatuses in which a white LED device is used, for example, fluorescent lamps.

1. A method of manufacturing a white light emitting diode (LED) device using a liquid epoxy resin, comprising:
mixing a main gradient with a curing agent at room temperature to obtain the liquid epoxy resin;
semi-curing the liquid epoxy resin at 70-1000° C. under 1-30 torr;
adding a phosphor to the semi-cured liquid epoxy resin at room temperature and mixing the phosphor and the semi-cured liquid epoxy resin to obtain a mother resin mixed with the phosphor;
feeding the obtained product into an element to be molded comprising a LED chip; and
completely curing the mother resin at 120° C. or higher under an ambient pressure.

2. The method of claim 1, wherein the feeding the mother resin is performed using a potting method or a screen pattern masking method.

3. The method of claim 1, wherein the main gradient is cresol novolac epoxy, phenol novolac epoxy, bisphenol A epoxy, or a mixture thereof and the curing agent is an acid anhydride, a modified aromatic amine, phenol novolac epoxy, or a mixture thereof.

4. The method of claim 1, wherein a phosphor is further added during the mixing of the main gradient with the curing agent.
